(19) United States
(12) Patent Application Publication
(10) Pub. No.: US 2026/0245373 A1
(43) Pub. Date: Aug. 20, 2026

(54) DYNAMIC LOCATION INFORMATION DISPLAY SYSTEM AND METHOD

(71) Applicant: Qisda Corporation, Taoyuan City (TW)

(72) Inventors: SZU-CHEN PENG, Taoyuan City (TW); CHIH-HUNG WU, Taoyuan City (TW)

(73) Assignee: Qisda Corporation, Taoyuan City (TW)

(21) Appl. No.: 19/441,260

(22) Filed: Jan. 6, 2026

(30) Foreign Application Priority Data
Feb. 14, 2025 (CN) 202510168054.7

(51) Int. Cl. G06V 20/54; G06T 7/70; G09G 3/32; G09G 5/36

(52) U.S. Cl. CPC G06V 20/54; G06T 7/70; G09G 3/32; G09G 5/36

(57) ABSTRACT

A dynamic location information display system is disclosed. The dynamic location information display system includes a first image capturing unit, a first processing unit and a first display unit. The first image capturing unit is configured to use a first image capturing range to obtain a first image of a pedestrian on a road. The first processing unit is coupled to the first image capturing unit. The first processing unit is configured to convert the first image into a first dynamic location information related to the pedestrian. The first display unit is coupled to the first processing unit. The first display unit is configured to graphically display the first dynamic location information.

### BACKGROUND OF THE INVENTION

### Field of the invention

The invention relates to a location display system and a location display method; in particular, to a dynamic location information display system and a dynamic location information display method.

### Description of the prior art

According to statistics, the number of accidents involving pedestrians on the road is increasing day by day, and a certain proportion of these accidents are related to the vehicle drivers. When the driver drives the vehicle through the intersection, it is very likely that the driver cannot immediately confirm the location of surrounding pedestrians on the road due to various factors, causing an accident. For example, a visual blind spot is created when the vision of the driver is blocked by the A-pillar of the car, the intersection is too large and the visual angle of the driver is limited, the pedestrians walk at different speeds, the different heights of the pedestrians, and the poor vision of the driver due to insufficient lighting at night.

Therefore, it is necessary to design a novel dynamic location information display system and method to overcome the above-mentioned defects.

### SUMMARY OF THE INVENTION

The purpose of the invention is to provide a dynamic location information display system and a dynamic location information display method, which can detect and graphically display the location information of the pedestrians in the range of the road around the vehicle in real time to the vehicle driver, so that the possibility of the pedestrian accidents can be effectively reduced.

In order to achieve the above-mentioned purpose, a dynamic location information display system is disclosed in the invention. The dynamic location information display system includes: a first image capturing unit, configured to use a first image capturing range to obtain a first image of a pedestrian on a road; a first processing unit, coupled to the first image capturing unit and configured to convert the first image into a first dynamic location information related to the pedestrian; and a first display unit, coupled to the first processing unit and configured to graphically display the first dynamic location information.

In an embodiment, the first display unit has a first display area corresponding to the first image capturing range and the first dynamic location information is graphically displayed on the first display area.

In an embodiment, the dynamic location information display system further includes a second display unit, wherein the second display unit and the first display unit are disposed at different heights or view angles, and the second display unit is coupled to the first processing unit and configured to graphically display the first dynamic location information.

In an embodiment, the dynamic location information display system further includes a second image capturing unit configured to use a second image capturing range to obtain a second image of the pedestrian on the road, wherein the second image capturing range is relative to the first image capturing range.

In an embodiment, the dynamic location information display system further includes: a second processing unit coupled to the second image capturing unit and configured to convert the second image into a second dynamic location information related to the pedestrian; and a second display unit coupled to the second processing unit and configured to graphically display the second dynamic location information.

In an embodiment, the second processing unit further receives the first image from the first image capturing unit and generates the second dynamic location information according to the first image and the second image.

In an embodiment, the second display unit has a second display area corresponding to the second image capturing range and at least one second dynamic location information is graphically displayed on the second display area.

In an embodiment, the first display unit and the second display unit include a plurality of light-emitting diode (LED) components, and light sensing ranges of the first image capturing unit and the second image capturing unit include the infrared light.

In an embodiment, the first processing unit further receives the second image from the second image capturing unit and generates the first dynamic location information according to the first image and the second image.

The invention also provides a dynamic location information display method including the following steps: (a) using a first image capturing range to obtain a first image of a pedestrian on a road; (b) converting the first image into a first dynamic location information related to the pedestrian; and (c) graphically display the first dynamic location information.

In an embodiment, in the step (c), the first dynamic location information is graphically displayed on a first display unit and a second display unit respectively disposed at different heights or viewing angles.

In an embodiment, the dynamic location information display method further includes: (d) using a second image capturing range to obtain a second image of the pedestrian on the road, wherein the second image capturing range is relative to the first image capturing range.

In an embodiment, the dynamic location information display method further includes: (e) converting the second image into a second dynamic location information related to the pedestrian; and (f) graphically displaying the second dynamic location information.

In an embodiment, the step (e) generates the second dynamic location information according to the first image and the second image.

In an embodiment, in the step (f), the first dynamic location information is graphically displayed on a second display area corresponding to the second image capturing range in the second display unit.

In an embodiment, the dynamic location information display method further includes a plurality of light-emitting diode (LED) components graphically displaying the first dynamic location information and the second dynamic location information.

In an embodiment, the step (b) generates the first dynamic location information according to the first image and the second image.

Compared to the prior art, the dynamic location information display system and method of the invention can convert the images of the pedestrians on the road obtained within the image capturing range into the pedestrian dynamic location information, and graphically display the pedestrian dynamic location information by the micro-LED display unit disposed at the intersection. Even at night or in an environment with poor visibility, the pedestrian dynamic location information can be clearly displayed for the vehicle driver to see, so when the vehicle driver passes through the intersection, the driver can immediately and intuitively know the location of the pedestrians on the road and have enough reaction time to avoid hitting the pedestrians, thereby effectively reducing the traffic accidents caused by pedestrian casualties due to factors such as the visual blind spot or poor night vision of the driver.

The advantage and spirit of the invention may be understood by the following detailed descriptions together with the appended drawings.

### BRIEF DESCRIPTION OF THE APPENDED DRAWINGS

FIG. 1 illustrates a schematic diagram of a dynamic location information display system in an embodiment of the invention.

FIG. 2 illustrates a schematic diagram of a first display unit in a dynamic location information display system graphically displaying the pedestrian dynamic location information in an embodiment the invention.

FIG. 3 illustrates a schematic diagram of a dynamic location information display system in another embodiment of the invention.

FIG. 4 illustrates a schematic diagram of two display units at different heights in a dynamic location information display system graphically displaying the same pedestrian dynamic location information in an embodiment of the invention.

FIG. 5 illustrates a schematic diagram of a dynamic location information display system in another embodiment of the invention.

FIG. 6 illustrates a schematic diagram showing that two display units respectively disposed on both sides of a pedestrian crossing in a dynamic location information display system graphically display the corresponding pedestrian dynamic location information in an embodiment of the invention.

FIG. 7 illustrates a schematic diagram of a dynamic location information display system in another embodiment of the invention.

FIG. 8 illustrates a schematic diagram showing that four display units at different heights respectively disposed on both sides of a pedestrian crossing in a dynamic location information display system graphically display the corresponding pedestrian dynamic location information in an embodiment of the invention.

FIG. 9 illustrates a flow chart of a dynamic location display method in another embodiment of the invention.

FIG. 10 illustrates a schematic diagram showing that when a vehicle driver is turning at an intersection, the driver can intuitively and instantly see the pedestrian dynamic location information graphically displayed by the display unit of the dynamic location information display system to avoid hitting pedestrians due to the blind spot of the driver.

FIG. 11 illustrates a schematic diagram showing that the dynamic location information display system applied to an intersection in an embodiment of the invention.

FIG. 12 illustrates a flow chart of a dynamic location display method in another embodiment of the invention.

### DETAILED DESCRIPTION OF THE INVENTION

To provide a further understanding of the purpose, structure, features and functions of the invention, the following detailed description is given in conjunction with the embodiments.

A specific embodiment of the invention is a dynamic location information display system. In this embodiment, the dynamic location information display system can be applied to the field of road traffic safety, but not limited to this. The dynamic location information display system can first obtain the images of the pedestrians within the range of the road to be detected and convert them into the pedestrian dynamic location information, and then graphically display the pedestrian dynamic location information by the micro-LED display unit disposed at the intersection, so when the vehicle driver passes through the intersection, the vehicle driver can instantly and intuitively know the location of the pedestrians on the surrounding roads, thereby effectively avoiding the traffic accidents that cause pedestrian casualties due to the factors such as the visual blind spot or poor night vision of the driver in the prior art.

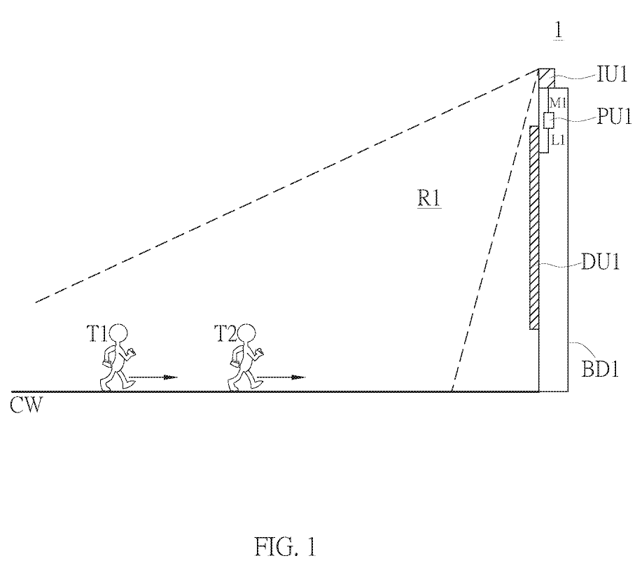

Please refer to FIG. 1. FIG. 1 illustrates a schematic diagram of a dynamic location information display system 1 in this embodiment. As shown in FIG. 1, the dynamic location information display system 1 includes a first body BD1, a first image capturing unit IU1, a first processing unit PU1 and a first display unit DU1. The first image capturing unit IU1 is disposed above the first body BD1. The first processing unit PU1 is disposed in the first body BD1. The first display unit DU1 is disposed on a side of the first body BD1 facing the intersection. The first processing unit PU1 is coupled to the first image capturing unit IU1. The first display unit DU1 is coupled to the first processing unit PU1.

In practical applications, the first image capturing unit IU1 may be, for example, a charge-coupled device (CCD) or a complementary metal-oxide-semiconductor (CMOS) image sensor, etc., with an image-capturing function, but not limited to this. The first processing unit PU1 may be, for example, a microcontroller unit (MCU) or a central processing unit (CPU), etc., with a computing and processing function, but not limited to this. The first display unit DU1 may be, for example, a micro light-emitting diode (Micro LED) display panel, etc., with advantages such as high-brightness, high-efficiency and fast response time, which allows the vehicle driver to clearly see the image displayed on the first display unit DU1 even at night or in an environment with poor visibility, but not limited to this.

The first image capturing unit IU1 is configured to use a first image capturing range R1 to shoot a road (e.g., a pedestrian crossing) CW to obtain a first image M1 of the pedestrians T1~T2 walking on the road CW, and transmit the first image M1 to the first processing unit PU1. The first processing unit PU1 is configured to convert the first image M1 into a first dynamic location information L1 related to the pedestrians T1~T2 and transmit the first dynamic location information L1 to the first display unit DU1. The first display unit DU1 is configured to graphically display the first dynamic location information L1.

In practical applications, the first processing unit PU1 may identify a first location of the pedestrians T1~T2 from the first image M1, and accordingly obtain a second location of the pedestrians T1~T2 within the first image capturing range R1, wherein the first dynamic location information L1 may include the second location and the change of the second location at different times, but not limited to this. The first image capturing range R1 used by the first image capturing unit IU1 can be set according to the image capturing capability of the first image capturing unit IU1, the length and width of the road (such as the pedestrian crossing) CW and other parameters, and not limited to this. The dynamic location information display system 1 can be disposed at any place where the dynamic location information L1 of the pedestrian needs to be detected and displayed according to practical needs, and the locations where the first image capturing unit IU1, the first processing unit PU1 and the first display unit DU1 are disposed can also be adjusted according to practical needs, and not limited to this.

It should be noted that the configuration of the dynamic location information display system 1 in this embodiment is intuitive and simple, so that the vehicle driver can immediately know the location of the pedestrian through the screen displayed by the first display unit DU1. On the other hand, it is also easier for maintenance personnel to perform system maintenance, and it can be clearly displayed regardless of day, night or different weather conditions, and the system recognition is almost not affected by external changes. Incidentally, the photosensitive range of the first image capturing unit IU1 can include the infrared light in addition to the visible light. In an embodiment, the first image capturing unit IU1 can detect visible light during the day to form the first image M1, and detect infrared light at night to form the first image M1. In this way, when shooting at night, it is not easy to reduce the accuracy of image analysis due to insufficient visible light contrast. In other embodiments, whether it is day or night, the first image M1 can also include both the visible light images and the infrared light images to further improve the accuracy of image analysis.

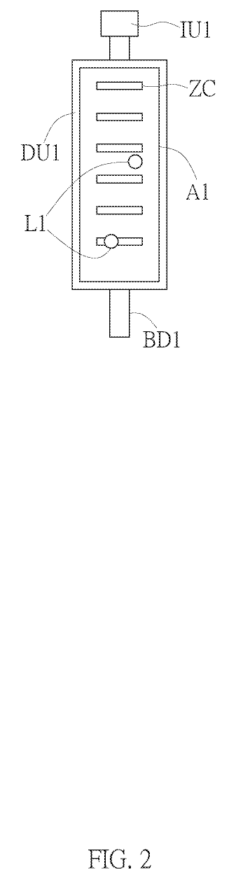

Please refer to FIG. 2. FIG. 2 illustrates a schematic diagram of the first display unit DU1 in the dynamic location information display system 1 graphically displaying the first dynamic location information L1 related to the pedestrians T1~T2. As shown in FIG. 2, the first display unit DU1 has a first display area A1 for graphically displaying the first dynamic location information L1. In this embodiment, the first dynamic location information L1 is the location of the pedestrian on the road (e.g., pedestrian crossing) CW. A zebra crossing ZC on the road (e.g., pedestrian crossing) CW in FIG. 1 and a location of pedestrian walking on the zebra crossing ZC are graphically displayed in the first display area A1 of the first display unit DU1, so when the vehicle driver passes through the intersection, the vehicle driver can immediately know the location of the pedestrians walking on the zebra crossing ZC by looking at the screen displayed in the first display area A1 of the first display unit DU1, effectively avoiding the pedestrian from the car accident due to the factors such as the blind spot or poor night vision of the driver. It should be noted that although the road CW of the invention is not limited to the area of the zebra crossing ZC, the zebra crossing ZC usually has a specific shape of spaced stripes, which can be used as a clear background pattern in image analysis. In this way, when the pedestrians T1~T2 are shown in the first image M1, the first processing unit PU1 can more easily distinguish the image parts of the pedestrians T1~T2 to improve the accuracy of image analysis. Incidentally, the concept of the invention can still be applied to other roads CW where the zebra crossings ZC are not disposed. Through the application of artificial intelligence (AI) big data analysis, regardless of whether there is the zebra crossing ZC as a background feature, the dynamics of pedestrians T1~T2 on the road CW can be correctly analyzed by artificial intelligence. Therefore, in the first display unit DU1, the first display area A1 corresponding to the road CW can also cancel the display of the zebra crossing ZC or replace it with other features of the road CW.

In another embodiment, to prevent the vision of the vehicle driver from being blocked by other vehicles or objects and being unable to see the pedestrian location image displayed by the first display unit DU1 of FIG. 2, when the vehicle driver passes through the intersection, the dynamic location information display system can also simultaneously include two display units disposed at different heights or viewing angles respectively to solve this problem.

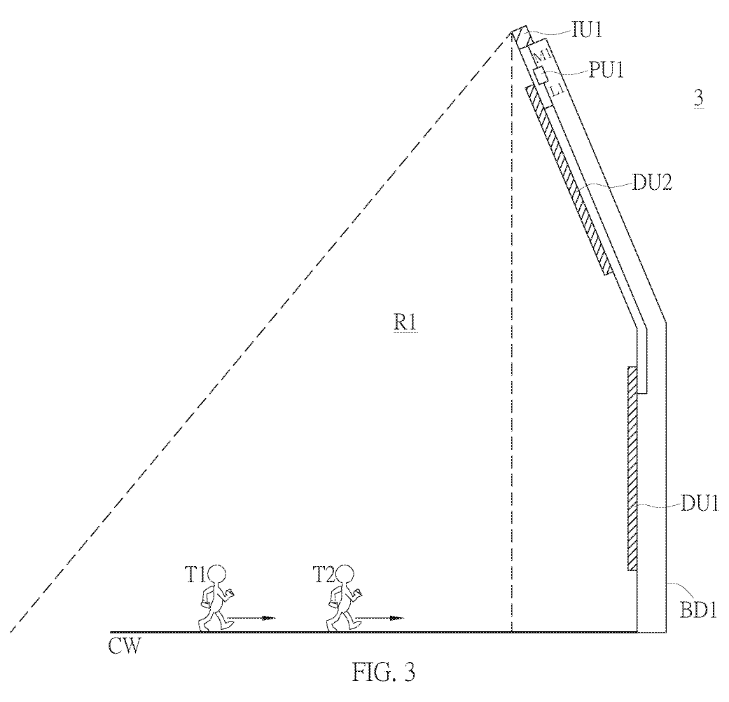

Please refer to FIG. 3. FIG. 3 illustrates a schematic diagram of the dynamic location information display system 3 in this embodiment. As shown in FIG. 3, the dynamic location information display system 3 includes a first body BD1, a first image capturing unit IU1, a first processing unit PU1, a first display unit DU1 and a second display unit DU2. The first image capturing unit IU1 is disposed above the first body BD1. The first processing unit PU1 is disposed in the first body BD1. The first processing unit PU1 is coupled to the first image capturing unit IU1. The first display unit DU1 and the second display unit DU2 are coupled to the first processing unit PU1.

The first image capturing unit IU1 shoots the road (e.g., pedestrian crossing) CW with the first image capturing range R1 to obtain the first image M1 of the pedestrians T1~T2 walking on the road CW. The first processing unit PU1 converts the first image M1 into a first dynamic location information L1 related to the pedestrians T1~T2, and then the first display unit DU1 and the second display unit DU2 graphically display the first dynamic location information L1. Incidentally, although the first image capturing unit IU1 of this embodiment is disposed above the first body BD1, it can be disposed between the first display unit DU1 and the second display unit DU2 (approximately in the middle area of the first body BD1) according to the practical shooting range. As mentioned above, the location of the first image capturing unit IU1 can be adjusted according to practical needs, and the invention is not limited to this.

It should be noted that the first display unit DU1 and the second display unit DU2 are both disposed on a side of the first body BD1 facing the intersection, but the first display unit DU1 and the second display unit DU2 are disposed at different heights or viewing angles respectively. In this embodiment, the second display unit DU2 is disposed at a higher location relative to the first display unit DU1, but not limited to this. The first display unit DU1 and the second display unit DU2 both display the same first dynamic location information L1. When the vehicle driver passes through the intersection, even if the vision of the vehicle driver is blocked by other vehicles or objects and the vehicle driver cannot clearly see the first dynamic location information L1 displayed on the first display unit DU1 disposed at a lower location, the driver can still look up to see the first dynamic location information L1 displayed on the second display unit DU2 disposed at a higher location, so as to immediately know the location of the pedestrians T1~T2 walking on the road CW.

In practical applications, the first display unit DU1 and the second display unit DU2 may be, for example, components with image display functions such as micro light-emitting diode (Micro LED) display panels with advantages such as high brightness, high efficiency and fast response time, which can allow the driver to clearly see the displayed screens even at night or in environments with poor visibility, but not limited to this.

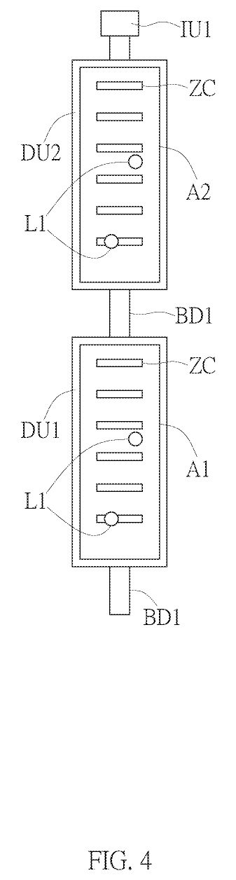

Please refer to FIG. 4. FIG. 4 illustrates a schematic diagram showing that the first display unit DU1 and the second display unit DU2 in the dynamic location information display system 3 graphically display the first dynamic location information L1 related to the pedestrians T1~T2. As shown in FIG. 4, the second display unit DU2 is disposed at a higher location and the first display unit DU1 is disposed at a lower location. The first display unit DU1 has a first display area A1 and the second display unit DU2 has a second display area A2. The first display area A1 and the second display area A2 are both used to graphically display the first dynamic location information L1.

In this embodiment, the first dynamic location information L1 is the location of the pedestrian on the road (e.g., a pedestrian crossing) CW. The first display area A1 of the first display unit DU1 and the second display area A2 of the second display unit DU2 both graphically display the zebra crossing ZC on the road (e.g., a pedestrian crossing) CW in FIG. 3 and the location of the pedestrians walking on the zebra crossing ZC. When the vehicle driver passes through the intersection, the driver can see the screen displayed in the first display area A1 of the first display unit DU1 disposed at the lower location by looking straight ahead, and immediately know the location of the pedestrians walking on the zebra crossing ZC. When the vision of the vehicle driver is blocked and the vehicle driver cannot clearly see the screen displayed in the first display area A1 of the first display unit DU1, the vehicle driver can also look up to see the screen displayed in the second display unit DU2 disposed at the higher location, and immediately know the location of the pedestrians walking on the zebra crossing ZC.

In another embodiment, since the image capturing range of the single image capturing unit in the above-mentioned embodiment may not cover all areas of the road (e.g., the pedestrian crossing) that the dynamic location information display system wants to detect, the pedestrians in some areas cannot be detected. Therefore, the dynamic location information display system may also include two image capturing units respectively disposed on both sides of the road (e.g., the pedestrian crossing) to solve this problem.

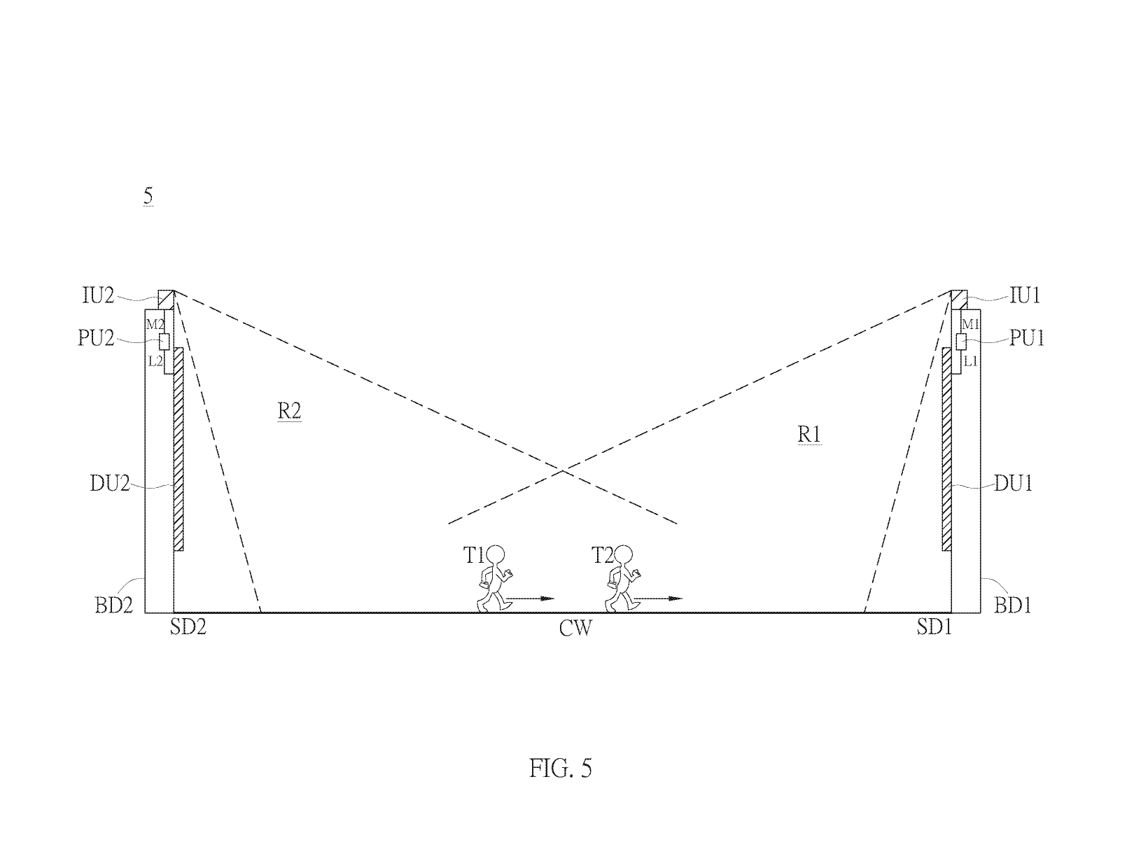

Please refer to FIG. 5. FIG. 5 illustrates a schematic diagram of the dynamic location information display system 5 in this embodiment. As shown in FIG. 5, the dynamic location information display system 5 includes a first body BD1, a first image capturing unit IU1, a first processing unit PU1, a first display unit DU1, a second body BD2, a second image capturing unit IU2, a second processing unit PU2 and a second display unit DU2. Among them, the first body BD1, the first image capturing unit IU1, the first processing unit PU1 and the first display unit DU1 are disposed on the first side SD1 of the road (e.g., the pedestrian crossing) CW, and the second body BD2, the second image capturing unit IU2, the second processing unit PU2 and the second display unit DU2 are disposed on the second side SD2 of the road (e.g., the pedestrian crossing) CW.

The first image capturing unit IU1 is disposed above the first body BD1. The first processing unit PU1 is disposed in the first body BD1. The first processing unit PU1 is coupled to the first image capturing unit IU1. The first display unit DU1 is coupled to the first processing unit PU1. The second image capturing unit IU2 is disposed above the second body BD2. The second processing unit PU2 is disposed in the second body BD2. The second processing unit PU2 is coupled to the second image capturing unit IU2. The first display unit DU1 is coupled to the first processing unit PU1.

In practical applications, the first image capturing unit IU1 and the second image capturing unit IU2 can be, for example, charge coupled device (CCD) or complementary metal-oxide-semiconductor (CMOS) image sensor and other components with image capturing function, but not limited to this. The first processing unit PU1 and the second processing unit PU2 can be, for example, micro control unit (MCU) or central processing unit (CPU) and other components with computing processing function, but not limited to this. The first display unit DU1 and the first display unit DU2 can be, for example, micro light-emitting diode (Micro LED) display panel with advantages of high brightness, high efficiency and fast response time and other components with image display function, but not limited to this.

The first image capturing unit IU1 disposed on the first side SD1 of the road (e.g., a pedestrian crossing) CW uses a first image capturing range R1 to shoot the road CW from the first side SD1 of the road CW to obtain a first image M1 related to the pedestrians T1~T2 walking on the road CW, and the first processing unit PU1 converts the first image M1 into a first dynamic location information L1 related to the pedestrians T1~T2, and then the first display unit DU1 disposed on the first side SD1 of the road CW graphically displays the first dynamic location information L1.

Similarly, the second image capturing unit IU2 disposed on the second side SD2 of the road CW uses a second image capturing range R2 to shoot the road CW from the second side SD2 of the road CW to obtain a second image M2 related to the pedestrians T1~T2 walking on the road CW, and the second processing unit PU2 converts the second image M2 into a second dynamic location information L2 related to the pedestrians T1~T2, and then the second display unit DU2 disposed on the second side SD2 of the road CW graphically displays the second dynamic location information L2.

In practical applications, the first image capturing range R1 and the second image capturing range R2 used by the first image capturing unit IU1 and the second image capturing unit IU2 respectively can be set according to the image capturing capability of the first image capturing unit IU1 and the second image capturing range R2, the length and the width of the road CW and other parameters, but not limited to this. The dynamic location information display system 1 can be disposed at any place where the dynamic location information L1 of the pedestrian to be detected and displayed according to practical needs, and the locations of the first image capturing unit IU1, the first processing unit PU1 and the first display unit DU1 can also be adjusted according to practical needs, and not limited to this.

It should be noted that since the first image M1 is taken from the first side SD1 of the road CW and the second image M2 is taken from the second side SD2 of the road CW opposite to the first side SD1, the first image M1 and the second image M2 are opposite to each other. Therefore, the first dynamic location information L1 converted from the first image M1 and the second dynamic location information L2 converted from the second image M2 are also opposite to each other; that is to say, the locations of the pedestrians T1~T2 detected from the first side SD1 of the road CW and the locations of the pedestrians T1~T2 detected from the second side SD2 of the road CW are opposite to each other.

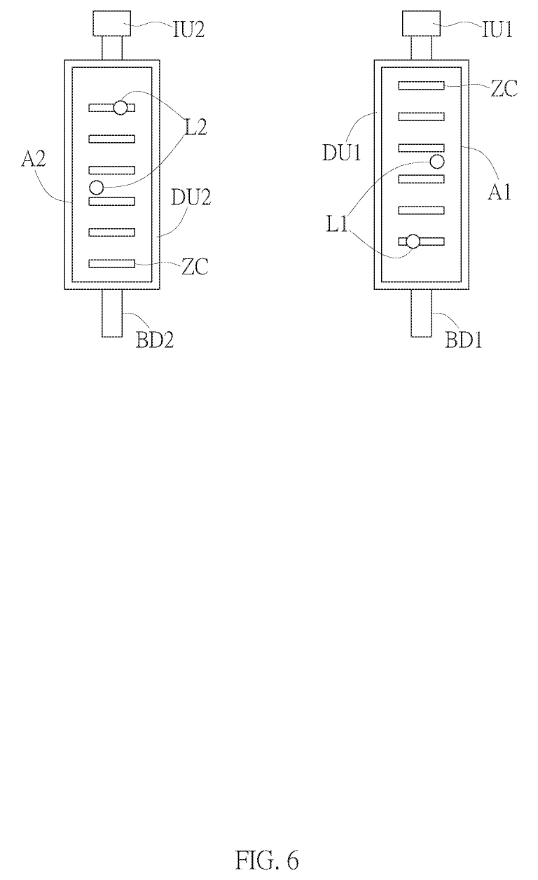

For example, please refer to FIG. 6. FIG. 6 illustrates a schematic diagram showing that the first display unit DU1 disposed on the first side SD1 of the road CW and the second display unit DU2 disposed on the second side SD2 of the road CW in the dynamic location information display system 5 graphically displaying the first dynamic location information L1 and the second dynamic location information L2 related to the pedestrians T1~T2 respectively.

As shown in FIG. 6, the first display unit DU1 disposed on the first side SD1 of the road CW has a first display area A1 and the second display unit DU2 disposed on the second side SD2 of the road CW has a second display area A2. The first dynamic location information L1 is graphically displayed in the first display area A1 of the first display unit DU1 and the second dynamic location information L2 is graphically displayed in the second display area A2 of the second display unit DU2.

It should be noted that the first dynamic location information L1 is converted from the first image M1 taken from the first side SD1 of the road CW, and the second dynamic location information L2 is converted from the second image M2 taken from the second side SD2 of the road CW opposite to the first side SD1. Since the first image M1 and the second image M2 taken from the first side SD1 and the second side SD2 of the road CW are opposite to each other (i.e., upside down), the first dynamic location information L1 displayed in the first display area A1 of the first display unit DU1 and the second dynamic location information L2 displayed in the second display area A2 of the second display unit DU2 are also opposite to each other (i.e., upside down).

For example, the zebra crossing ZC and the location of the pedestrian walking on the zebra crossing ZC displayed in the first display area A1 of the first display unit DU1 and the zebra crossing ZC and the location of the pedestrian walking on the zebra crossing ZC displayed in the second display area A2 of the second display unit DU2 are opposite to each other (e.g., upside down and left and right). In this way, whether the vehicle driver approaching the intersection from the first side SD1 of the road CW sees the first dynamic location information L1 displayed in the first display area A1 of the first display unit DU1, or the vehicle driver approaching the intersection from the second side SD2 of the road CW sees the second dynamic location information L2 displayed in the second display area A2 of the second display unit DU2, the vehicle driver can intuitively know the location of the pedestrians walking on the zebra crossing ZC based on the screen the vehicle driver sees.

It should be noted that the first processing unit PU1 of the dynamic location information display system 5 can simultaneously generate the first dynamic location information L1 according to the first image M1 of the first image capturing range R1 and the second image M2 of the second image capturing range R2, and the second processing unit PU2 can simultaneously generate the second dynamic location information L2 according to the first image M1 of the first image capturing range R1 and the second image M2 of the second image capturing range R2. In other words, the first processing unit PU1 and the second processing unit PU2 can simultaneously receive the first image M1 from the first image capturing unit IU1 and the second image M2 from the second image capturing unit IU2, and simultaneously integrate the first image M1 of the first image capturing range R1 and the second image M2 of the second image capturing range R2 to convert them into the first dynamic location information L1 and the second dynamic location information L2 respectively, so that the first dynamic location information L1 and the second dynamic location information L2 displayed on the first display unit DU1 and the second display unit DU2 can be more accurate and reliable. Incidentally, in this embodiment, the first processing unit PU1 is coupled to the second processing unit PU2, the first processing unit PU1 receives the second image M2 through the second processing unit PU2, and the second processing unit PU2 receives the first image M1 through the first processing unit PU1. However, the way in which the first processing unit PU1 and the second processing unit PU2 simultaneously receive the first image M1 and the second image M2 is not limited in the invention. For example, an additional central control processing unit may be provided to be coupled to the first processing unit PU1 and the second processing unit PU2 respectively. Those skilled in the art can easily understand and will not repeat the description.

In another embodiment, in order to prevent the vision of the vehicle driver from being blocked by other vehicles or objects when passing through the intersection from the first side SD1 or the second side SD2 of the road CW and unable to clearly see the pedestrian location images displayed by the first display unit DU1 and the second display unit DU2 of FIG. 6, the dynamic location information display system can also simultaneously provide two display units at different heights or viewing angles on the first side SD1 or the second side SD2 of the road CW to solve this problem.

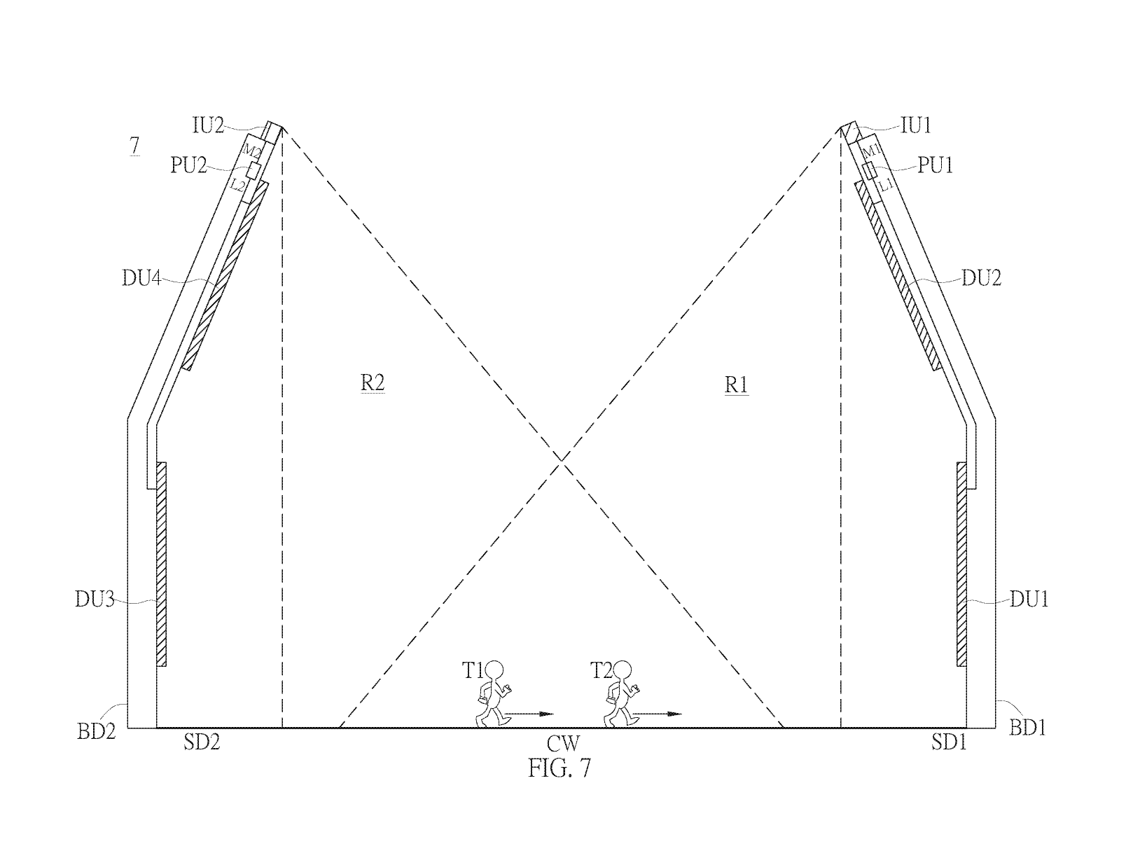

Please refer to FIG. 7. FIG. 7 illustrates a schematic diagram of the dynamic location information display system 7 in this embodiment. As shown in FIG. 7, the dynamic location information display system 7 includes a first body BD1, a first image capturing unit IU1, a first processing unit PU1, a first display unit DU1, a second display unit DU2, a second body BD2, a second image capturing unit IU2, a second processing unit PU2, a third display unit DU3 and a fourth display unit DU4. Among them, the first body BD1, the first image capturing unit IU1, the first processing unit PU1, the first display unit DU1 and the second display unit DU2 are disposed on a first side SD1 of the road CW, and the second body BD2, the second image capturing unit IU2, the second processing unit PU2, the third display unit DU3 and the fourth display unit DU4 are disposed on a second side SD2 of the road CW.

The first body BD1 is disposed on the first side SD1 of the road CW. The first image capturing unit IU1 is disposed above the first body BD1. The first processing unit PU1 is disposed in the first body BD1. The first processing unit PU1 is coupled to the first image capturing unit IU1. The first display unit DU1 and the second display unit DU2 are coupled to the first processing unit PU1. The first image capturing unit IU1 uses a first image capturing range R1 to shoot the road CW from a first side SD1 of the road CW to obtain a first image M1 of the pedestrians T1~T2 walking on the road CW. The first processing unit PU1 converts the first image M1 into a first dynamic location information L1 related to the pedestrians T1~T2, and then the first display unit DU1 and the second display unit DU2 graphically display the first dynamic location information L1.

The second body BD2 is disposed on the second side SD2 of the road CW. The second image capturing unit IU2 is disposed above the second body BD2. The second processing unit PU2 is disposed in the second body BD2. The second processing unit PU2 is coupled to the second image capturing unit IU2. The third display unit DU3 and the fourth display unit DU4 are coupled to the second processing unit PU2. The second image capturing unit IU2 uses the second image capturing range R2 to shoot the road CW from the second side SD2 of the road CW to obtain the second image M2 of the pedestrians T1~T2 walking on the road CW. The second processing unit PU2 converts the second image M2 into a second dynamic location information L2 related to the pedestrians T1~T2, and then the third display unit DU3 and the fourth display unit DU4 graphically display the second dynamic location information L2.

It should be noted that the first display unit DU1 and the second display unit DU2 disposed on the first side SD1 of the road CW are disposed at different heights or viewing angles of the first body BD1 respectively. In this embodiment, the second display unit DU2 is disposed at a higher location relative to the first display unit DU1, but not limited to this. The first display unit DU1 and the second display unit DU2 both display the same first dynamic location information L1. When the vehicle driver passes through the intersection on the first side SD1 of the road CW, even if the vision of the vehicle driver is blocked by other vehicles or objects and the vehicle driver cannot clearly see the first dynamic location information L1 displayed on the first display unit DU1 disposed at a lower location, the vehicle driver can still look up and see the first dynamic location information L1 displayed on the second display unit DU2 disposed at a higher location, so that the vehicle driver can immediately know the locations of the pedestrians T1~T2 walking on the road CW.

Similarly, the third display unit DU3 and the fourth display unit DU4 disposed on the second side SD2 of the road CW are disposed at different heights or viewing angles of the second body BD2. In this embodiment, the fourth display unit DU4 is disposed at a higher location relative to the third display unit DU3, but not limited to this. The third display unit DU3 and the fourth display unit DU4 both display the same second dynamic location information L2. When the vehicle driver passes through the intersection on the second side SD2 of the road CW, even if the vision of the vehicle driver is blocked by other vehicles or objects and the vehicle driver cannot clearly see the second dynamic location information L2 displayed on the third display unit DU3 disposed at the lower location, the vehicle driver can still look up to see the second dynamic location information L2 displayed on the fourth display unit DU4 disposed at the higher location, so that the vehicle driver can immediately know the locations of the pedestrians T1~T2 walking on the road CW.

In practical applications, the first display unit DU1 to the fourth display unit DU4 may be, for example, components with image display function such as a micro light-emitting diode (Micro LED) display panel having advantages such as high brightness, high efficiency and fast response time, so that the driver can clearly see the displayed images even at night or in an environment with poor visibility, but not limited to this.

It should be noted that the first dynamic location information L1 is converted from the first image M1 taken from the first side SD1 of the road CW, and the second dynamic location information L2 is converted from the second image M2 taken from the second side SD2 of the road CW. Since the first image M1 and the second image M2 taken from the first side SD1 and the second side SD2 of the road CW are opposite to each other (i.e., upside down and left and right), the first dynamic location information L1 displayed on the first display unit DU1 and the second display unit DU2 and the second dynamic location information L2 displayed on the third display unit DU3 and the fourth display unit DU4 are also opposite to each other (i.e., upside down and left and right).

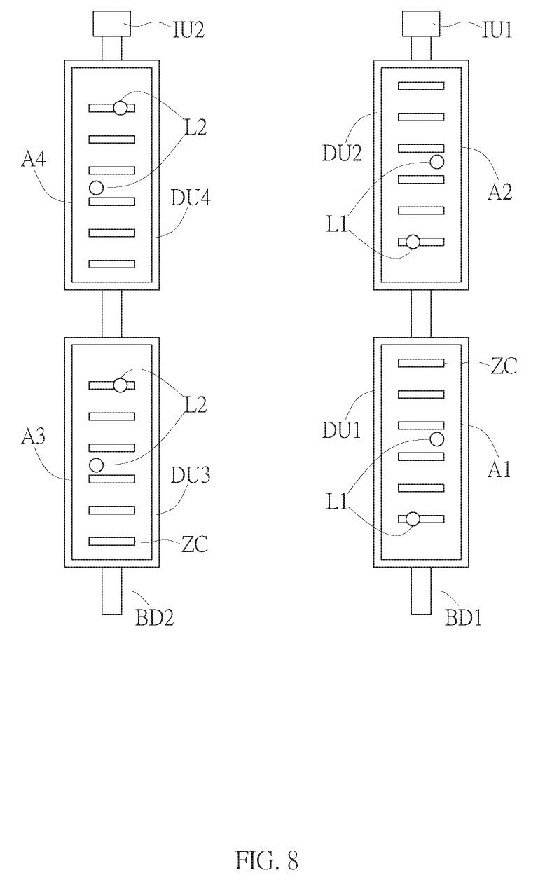

As shown in FIG. 8, the first display unit DU1 and the second display unit DU2 disposed on the first side SD1 of the road CW have a first display area A1 and a second display area A2 respectively. The first dynamic location information L1 is graphically displayed in the first display area A1 and the second display area A2. The third display unit DU3 and the fourth display unit DU4 disposed on the second side SD2 of the road CW have a third display area A3 and a fourth display area A4 respectively. The second dynamic location information L2 is graphically displayed in the third display area A3 and the fourth display area A4.

It should be noted that the first dynamic location information L1 is converted from the first image M1 taken from the first side SD1 of the road CW, and the second dynamic location information L2 is converted from the second image M2 taken from the second side SD2 of the road CW opposite to the first side SD1. Since the first image M1 and the second image M2 taken from the first side SD1 and the second side SD2 of the road CW are opposite to each other (i.e., upside down and left and right), the first dynamic location information L1 displayed in the first display area A1 of the first display unit DU1 and the second display area A2 of the second display unit DU2 are opposite to the second dynamic location information L2 displayed in the third display area A3 of the third display unit DU3 and the fourth display area A4 of the fourth display unit DU4 (i.e., upside down and left and right).

For example, the zebra crossing ZC and the locations of the pedestrians walking on the zebra crossing ZC displayed in the first display area A1 of the first display unit DU1 and the second display area A2 of the second display unit DU2 are opposite to the zebra crossing ZC and the locations of pedestrians walking on the zebra crossing ZC displayed in the third display area A3 of the third display unit DU3 and the fourth display area A4 of the fourth display unit DU4 (for example, upside down).

Thus, whether the vehicle driver approaching the intersection from the first side SD1 of the road CW sees the first dynamic location information L1 displayed on the first display unit DU1 disposed at the lower location or the second display unit DU2 disposed at the higher location, or the vehicle driver approaching the intersection from the second side SD2 of the road CW sees the second dynamic location information L2 displayed on the third display unit DU3 disposed at the lower location or the fourth display unit DU4 disposed at the higher location, the vehicle driver can intuitively know the location of the pedestrians walking on the zebra crossing ZC according to the first dynamic location information L1 or the second dynamic location information L2 the vehicle driver sees.

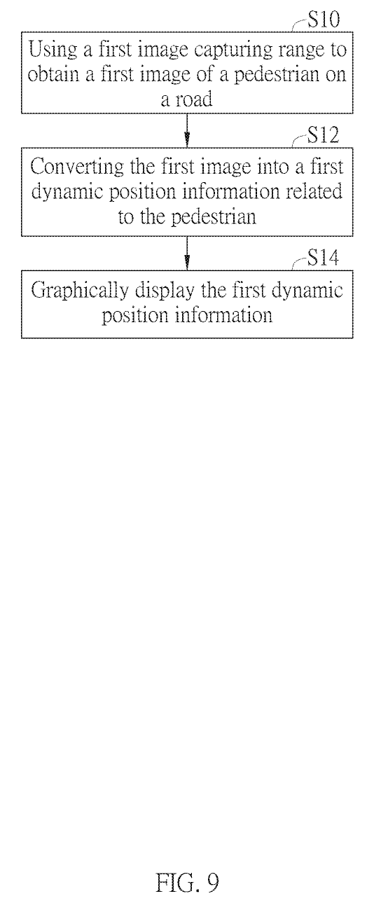

Another embodiment of the invention is a dynamic location information display method. Please refer to FIG. 9. FIG. 9 illustrates a flow chart of the dynamic location display method in this embodiment. As shown in FIG. 9, the dynamic location information display method includes the following steps:

Step S10: using a first image capturing range to obtain a first image of a pedestrian on a road;

Step S12: converting the first image into a first dynamic location information related to the pedestrian; and

Step S14: graphically displaying the first dynamic location information.

In practical applications, the step S12 can identify the first location of the pedestrian from the first image, and accordingly obtain the second location of the pedestrian within the first image capturing range, wherein the first dynamic location information can include the second location and the change of the second location at different times, but not limited to this. The step S14 can graphically display the first dynamic location information on the first display unit and the second display unit disposed at different heights or viewing angles respectively, and the first display unit and the second display unit can include a plurality of micro-LED components, but not limited to this. In another embodiment, the step S14 graphically displays the first dynamic location information in the first display area of the first display unit corresponding to the first image capturing range.

In another embodiment, the dynamic location information display method can also include steps of: obtaining a second image of the pedestrian within a second image capturing range of the road, wherein the second image capturing range is relative to the first image capturing range; converting the second image into a second dynamic location information related to the pedestrian; and graphically displaying the second dynamic location information, but not limited to this.

Next, different embodiments will be used to illustrate that when the vehicle driver is turning at an intersection, the dynamic location information display system and method of the invention can allow the vehicle driver to see the dynamic location information of the pedestrians graphically displayed in real time and know the locations of the pedestrians on the surrounding roads, thereby effectively avoiding car accidents caused by accidentally hitting the pedestrians.

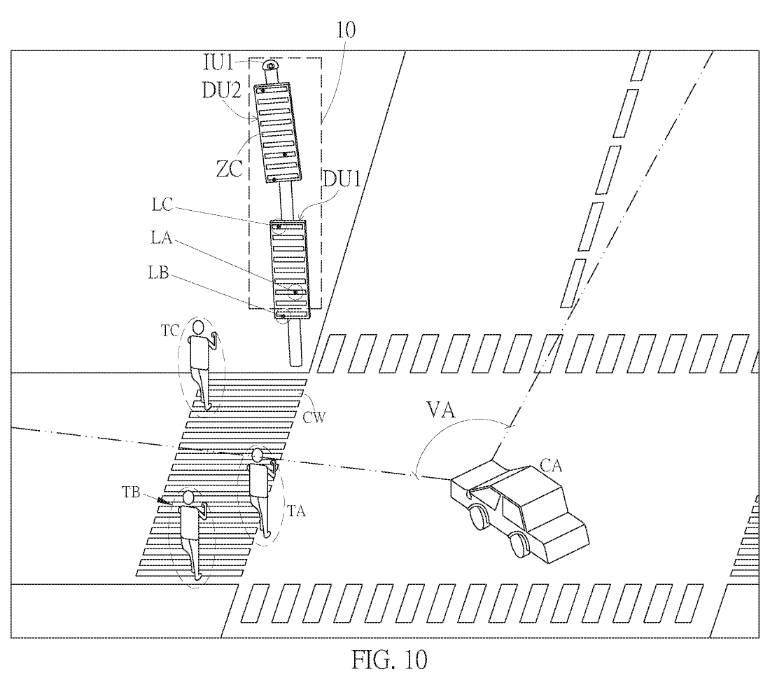

In an embodiment, as shown in FIG. 10, the dynamic location information display system 10 can be disposed at one side of the pedestrian crossing CW. When the vehicle CA turns left through the road (e.g., pedestrian crossing) CW, only the pedestrian TC can be seen within the viewing angle VA of the driver, but the pedestrians TA and TB cannot be seen within the viewing angle VA of the driver. At this time, the screen displayed on the first display unit DU1 and the second display unit DU2 of the dynamic location information display system 10 can be seen within the viewing angle VA of the driver in the vehicle CA, and the screen includes the dynamic location information LA of the pedestrian TA walking on the zebra crossing ZC, the dynamic location information LB of the pedestrian TB, and the dynamic location information LC of the pedestrian TC, so that the driver of the vehicle CA can clearly know that the pedestrians TA, TB, and TC are passing on the zebra crossing ZC, and the driver can pay attention to the driving speed to avoid pedestrian accidents.

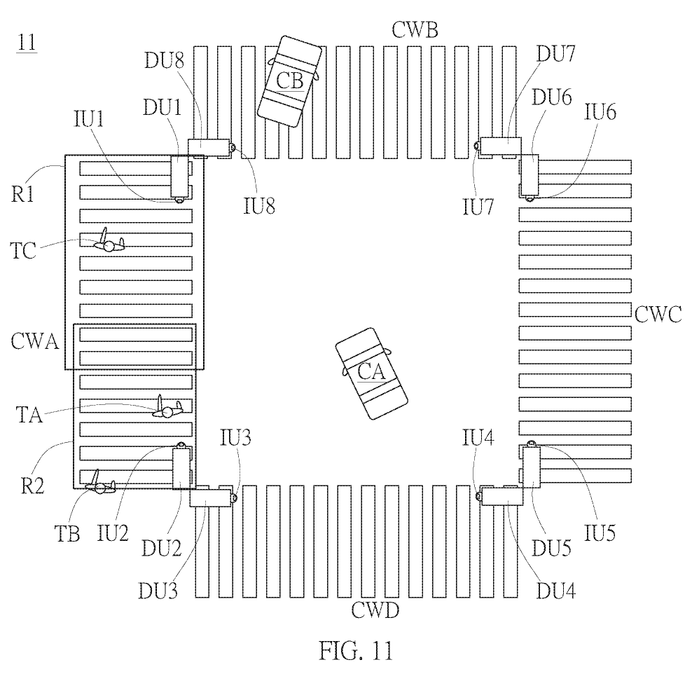

In another embodiment, as shown in FIG. 11, the dynamic location information display system 11 can be disposed at both sides of the four pedestrian crossings CWA~CWD at the intersection. The dynamic location information display system 11 includes a first image capturing unit IU1 to an eighth image capturing unit IU8 and a first display unit DU1 to an eighth display unit DU8. The first image capturing unit IU1 and the first display unit DU1 are disposed at one side of the pedestrian crossing CWA and the second image capturing unit IU2 and the second display unit DU2 are disposed at the other side of the pedestrian crossing CWA. The third image capturing unit IU3 and the third display unit DU3 are disposed at one side of the pedestrian crossing CWD and the fourth image capturing unit IU4 and the fourth display unit DU4 are disposed at the other side of the pedestrian crossing CWD. The fifth image capturing unit IU5 and the fifth display unit DU5 are disposed at one side of the pedestrian crossing CWC and the sixth image capturing unit IU6 and the sixth display unit DU6 are disposed at the other side of the pedestrian crossing CWC. The seventh image capturing unit IU7 and the seventh display unit DU7 are disposed at one side of the pedestrian crossing CWB and the eighth image capturing unit IU8 and the eighth display unit DU8 are disposed at the other side of the pedestrian crossing CWB.

Taking the pedestrian crossing CWA as an example, the first image capturing unit IU1 uses the first image capturing range R1 to shoot the pedestrian crossing CWA from one side of the pedestrian crossing CWA to obtain the first image M1 related to the first pedestrian TA to the third pedestrian TC, and the second image capturing unit IU2 uses the second image capturing range R2 to shoot the pedestrian crossing CWA from the other side of the pedestrian crossing CWA to obtain the second image M2 related to the first pedestrian TA to the third pedestrian TC. The dynamic location information display system 11 can identify the locations of the first pedestrian TA to the third pedestrian TC according to the first image M1 and convert them into the first dynamic location information L1 related to the first pedestrian TA to the third pedestrian TC, and identify the locations of the first pedestrian TA to the third pedestrian TC according to the second image M2 and convert them into the second dynamic location information L2 related to the first pedestrian TA to the third pedestrian TC, and then the first display unit DU1 disposed at one side of the pedestrian crossing CWA and the second display unit DU2 disposed on the other side of the pedestrian crossing CWA graphically display the first dynamic location information L1 and the second dynamic location information L2 respectively.

Thus, when the vehicle CA turns left through the pedestrian crossing CWA, its driver can clearly know the locations of the first pedestrian TA to the third pedestrian TC on the pedestrian crossing CWA through the first dynamic location information L1 displayed on the first display unit DU1. When the vehicle CB turns turn right through the pedestrian crossing CWA, its driver can clearly know the locations of the first pedestrian TA to the third pedestrian TC on the pedestrian crossing CWA through the second dynamic location information L2 displayed on the second display unit DU2. As for the operation mode of the dynamic location information display system 11 in other pedestrian crossings CWB, CWC, and CWD, it is similar to the operation mode of the pedestrian crossing CWA, so it will not be further described here. Incidentally, in this embodiment, the first image capturing range R1 and the second image capturing range R2 partially overlap in the middle part of the pedestrian crossing CWA. However, the first image capturing range R1 and the second image capturing range R2 may also roughly overlap or not overlap at all. The advantage of the former is that cross-comparison can be performed in image analysis through two different shooting angles to improve the accuracy, while the advantage of the latter is that the amount of calculation can be reduced, and the partial overlap in this embodiment can effectively achieve a balance.

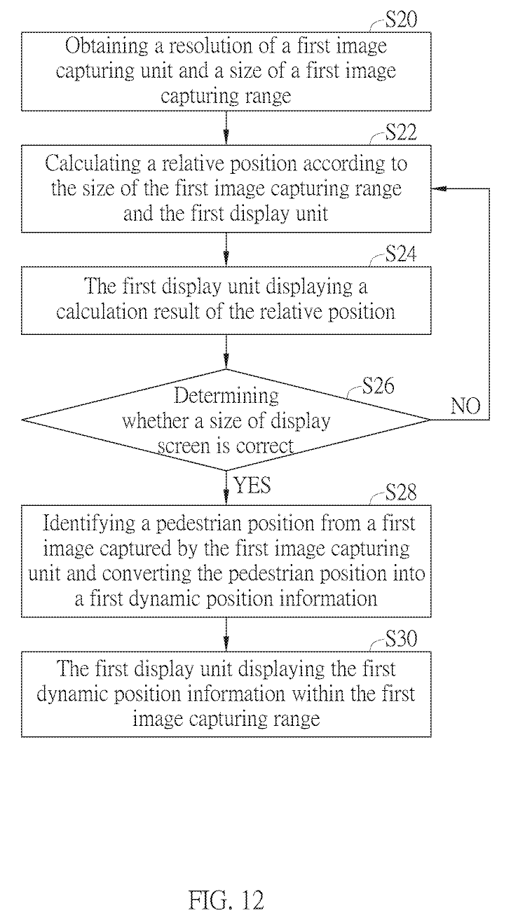

In another embodiment, as shown in FIG. 12, when the dynamic location display method of the invention is applied to the dynamic location information display system 1 in FIG. 1, for example, the dynamic location display method may include the following steps:

Step S20: obtaining a resolution of the first image capturing unit IU1 and a size of the first image capturing range R1;

Step S22: calculating a relative location according to the size of the first image capturing range R1 and the first display unit DU1;

Step S24: the first display unit DU1 displaying a calculation result of the relative location;

Step S26: determining whether a size of the display screen is correct;

If a determining result of the step S26 is NO, returning to the step S22;

If the determining result of the step S26 is YES, performing the step S28: identifying the pedestrian location from the first image M1 captured by the first image capturing unit IU1 and converting it into a first dynamic location information L1; and

Step S30: the first display unit DU1 displaying the first dynamic location information L1 within the first image capturing range R1.

From the description of the above embodiments, it can be found that the dynamic location information display system and method of the invention includes a first image capturing unit, a first processing unit and a first display unit. The first image capturing unit is configured to use a first image capturing range to obtain a first image of a pedestrian on a road. The first processing unit is coupled to the first image capturing unit. The first processing unit is configured to convert the first image into a first dynamic location information related to the pedestrian. The first display unit is coupled to the first processing unit. The first display unit is configured to graphically display the first dynamic location information. The image of the pedestrian obtained within the image capturing range of the road is converted into a pedestrian dynamic location information, and the pedestrian dynamic location information is graphically displayed on a micro-LED display unit disposed at the intersection. Even at night or in an environment with poor visibility, the pedestrian dynamic location information can be clearly displayed for the vehicle driver to see. When the vehicle driver passes through the intersection, the vehicle driver can immediately and intuitively know the location of the pedestrians on the road and have enough reaction time to avoid hitting the pedestrians, so that the traffic accidents caused by pedestrian casualties due to factors such as the visual blind spot or poor night vision of the vehicle driver can be effectively reduced.

Although the invention is described in conjunction with the accompanying drawings, the embodiments disclosed in the drawings are intended to exemplify the preferred embodiments of the invention and should not be construed as limiting the invention. To clearly describe the required components, the proportions in the schematic drawings do not represent the proportional relationship of the actual components.

The invention has been described by the above-mentioned relevant embodiments; however, the above-mentioned embodiments are only examples for implementing the invention. It must be pointed out that the disclosed embodiments do not limit the scope of the invention. On the contrary, changes and modifications made without departing from the spirit and scope of the invention are all within the scope of patent protection of the invention.

What is claimed is:

1. A dynamic location information display system, comprising:
a first image capturing unit configured to use a first image capturing range to obtain a first image of a pedestrian on a road;
a first processing unit coupled to the first image capturing unit and configured to convert the first image into a first dynamic location information related to the pedestrian; and
a first display unit coupled to the first processing unit and configured to graphically display the first dynamic location information.

2. The dynamic location information display system of claim 1, wherein the first display unit has a first display area corresponding to the first image capturing range and the first dynamic location information is graphically displayed on the first display area.

3. The dynamic location information display system of claim 1, further comprising:
a second display unit, wherein the second display unit and the first display unit are disposed at different heights or view angles, and the second display unit is coupled to the first processing unit and configured to graphically display the first dynamic location information.

4. The dynamic location information display system of claim 1, further comprising:
a second image capturing unit configured to use a second image capturing range to obtain a second image of the pedestrian on the road, wherein the second image capturing range is relative to the first image capturing range.

5. The dynamic location information display system of claim 4, further comprising:
a second processing unit coupled to the second image capturing unit and configured to convert the second image into a second dynamic location information related to the pedestrian; and
a second display unit coupled to the second processing unit and configured to graphically display the second dynamic location information.

6. The dynamic location information display system of claim 5, wherein the second processing unit further receives the first image from the first image capturing unit and generates the second dynamic location information according to the first image and the second image.

7. The dynamic location information display system of claim 5, wherein the second display unit has a second display area corresponding to the second image capturing range and the second dynamic location information is graphically displayed on the second display area.

8. The dynamic location information display system of claim 5, wherein the first display unit and the second display unit comprise a plurality of light-emitting diode (LED) components respectively, and light sensing ranges of the first image capturing unit and the second image capturing unit comprise infrared light.

9. The dynamic location information display system of claim 4, wherein the first processing unit further receives the second image from the second image capturing unit and generates the first dynamic location information according to the first image and the second image.

10. A dynamic location information display method, comprising steps of:
(a) using a first image capturing range to obtain a first image of a pedestrian on a road;
(b) converting the first image into a first dynamic location information related to the pedestrian; and
(c) graphically displaying the first dynamic location information.

11. The dynamic location information display method of claim 10, wherein in the step (c), the first dynamic location information is graphically displayed on a first display unit and a second display unit respectively, and the first display unit and the second display unit are disposed at different heights or viewing angles.

12. The dynamic location information display method of claim 10, further comprising:
(d) using a second image capturing range to obtain a second image of the pedestrian on the road, wherein the second image capturing range is relative to the first image capturing range.

13. The dynamic location information display method of claim 12, further comprising:
(e) converting the second image into a second dynamic location information related to the pedestrian; and
(f) graphically displaying the second dynamic location information.

14. The dynamic location information display method of claim 13, wherein the step (e) generates the second dynamic location information according to the first image and the second image.

15. The dynamic location information display method of claim 13, wherein in the step (f), the first dynamic location information is graphically displayed on a second display area corresponding to the second image capturing range in the second display unit.

16. The dynamic location information display method of claim 13, further comprising:
graphically displaying the first dynamic location information and the second dynamic location information by a plurality of light-emitting diode (LED) components.

17. The dynamic location information display method of claim 12, wherein the step (b) generates the first dynamic location information according to the first image and the second image.
